(19) United States
(12) Patent Application Publication
(10) Pub. No.: US 2024/0340558 A1
(43) Pub. Date: Oct. 10, 2024

(54) INTERNAL REFLECTION CANCELLATION FOR MULTI-PORT FULL DUPLEX NODE AND AMPLIFIER

(71) Applicant: ARRIS Enterprises LLC, Horsham, PA (US)

(72) Inventors: Zhijian SUN, Avon, CT (US); Marcel Franz Christian SCHEMMANN, Maria Hoop (NL); Brent D. ARNOLD, Doylestown, PA (US); Brian J. SOLOMON, Middlefield, CT (US); David C. Hartrum, Springfield, PA (US)

(73) Assignee: ARRIS Enterprises LLC, Horsham, PA (US)

(21) Appl. No.: 18/632,043

(22) Filed: Apr. 10, 2024

Related U.S. Application Data
(60) Provisional application No. 63/458,384, filed on Apr. 10, 2023.

(51) Int. Cl. H04Q 11/00; H04J 14/02

(52) U.S. Cl. CPC H04Q 11/0005; H04J 14/0204; H04Q 2011/0013; H04Q 2011/0049

(57) ABSTRACT

Devices, systems, and methods for an internal reflection cancelling full duplex node. The internal reflection cancelling full duplex node is a multi-port full duplex node configured for generating, splitting, and transmitting a downstream signal out a plurality of ports, configured for receiving multiple upstream signals, one through each of the ports, and configured for cancelling reflections of the downstream signal from the ports.

### CROSS REFERENCE TO RELATED APPLICATIONS

The present application claims priority to U.S. Provisional Application No. 63/458,384 filed Apr. 10, 2023, the content of which is incorporated herein by reference in its entirety.

### BACKGROUND

The subject matter of this application relates to amplifiers in full duplex communications architectures.

Cable Television (CATV) services typically provide content to large groups of subscribers from a central delivery unit, called a “head end,” which distributes channels of content to its subscribers from this central unit through a branch network comprising a multitude of intermediate nodes. Modern Cable Television (CATV) service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber and to the content provider through the branch network.

To this end, CATV head ends have historically included a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern CATV systems have combined the functionality of the CMTS with the video delivery system (EdgeQAM) in a single platform called the Converged Cable Access Platform (CCAP). Still other modern CATV systems called Remote PHY (or R-PHY) relocate the physical layer (PHY) of a traditional CCAP by pushing it to the network's fiber nodes. Thus, while the core in the CCAP performs the higher layer processing, the R-PHY device in the node converts the downstream data sent by the core to be transmitted on radio frequency from digital-to-analog, and converts the upstream RF data sent by cable modems to be transmitted optically to the core from analog-to-digital format.

Regardless of which architectures were employed, historical implementations of CATV systems bifurcated available bandwidth into upstream and downstream transmissions, i.e., data was only transmitted in one direction across any part of the spectrum. For example, early iterations of the Data Over Cable Service Interface Specification (DOCSIS) specified assigned upstream transmissions to a frequency spectrum between 5 MHz and 42 MHz and assigned downstream transmissions to a frequency spectrum between 50 MHz and 750 MHz. Though later iterations of the DOCSIS standard expanded the width of the spectrum reserved for each of the upstream and downstream transmission paths, the spectrum assigned to each respective direction did not overlap.

Full Duplex DOCSIS (FDX) is a DOCSIS 4.0 technology that enables higher data bandwidth for consumers. This technology shares the same frequency band (108-684 MHZ, for example) for downstream and upstream signals to support higher bandwidth. With FDX DOCSIS, upstream and downstream spectrum is no longer separated, allowing up to 5 Gbps upstream service and 10 Gbps downstream service over the cable access network. In a full duplex system, because the CCAP/R-PHY core knows the characteristics of its own downstream transmission, it can distinguish upstream communications transmitted in the same frequencies that it provides those downstream services. Cable modems receive data on the downstream and then transmit data on the upstream as scheduled by the Cable Modem Termination System (CMTS), but no cable modem will transmit and receive at the same time.

In previous versions of DOCSIS a cable modem was limited in the downstream with only one or two OFDM (Orthogonal Frequency Division Multiplexing) channels and in the upstream by having at best two OFDMA (Orthogonal Frequency Division Multiple Access) channels. While the modem could receive downstream and transmit upstream simultaneously, the upstream channels were shared with many other modems. The number of cable modems served by a node for FDX DOCSIS will almost always be smaller because there must not be active devices (i.e., amplifiers) after the node. With FDX DOCSIS, the modem has a minimum of four downstream OFDM channels and seven upstream OFDMA channels. The net result is much more bandwidth in the upstream and downstream to each modem. The time to switch between upstream and downstream transmitting is extremely short and managed by the CMTS, resulting in very high speeds for a particular cable modem.

Due to use of the same frequency band for downstream and upstream signals in FDX DOCSIS, a complex signal processing unit is required to process received FDX signals to cancel out the reflections or echoes. These echoes need to be cancelled in order to achieve the desired performance level. The total amount of echo cancellation (EC) by signal processing is limited. Since the reflections can be internal (from an FDX node or amplifier), or external (from the cable plant), minimizing the internal reflections as much as possible is desired in order to maintain as much of the total echo cancellation budget for a system as possible. In a multi-port FDX Node or amplifiers, the internal reflections from different output ports could add in phase, significantly increasing the reflection level. For example, for a two-port amplifier, the reflection from two output ports can add in-phase and increase the total internal reflections by 6 dB. What is needed is a way other than signal processing to cancel reflections internal to the FDX node.

### BRIEF DESCRIPTION OF THE DRAWINGS

For a better understanding of the invention, and to show how the same may be carried into effect, reference will now be made, by way of example, to the accompanying drawings, in which:

FIG. 1 shows a first exemplary embodiment of an internal reflection cancelling full duplex node 100 (two-port).

FIG. 2 shows a second exemplary embodiment of an internal reflection cancelling full duplex node 200 (two-port).

FIG. 3 shows a third exemplary embodiment of an internal reflection cancelling full duplex node 300 (three-port).

FIG. 4 shows a fourth exemplary embodiment of an internal reflection cancelling full duplex node 400 (four-port).

### DETAILED DESCRIPTION

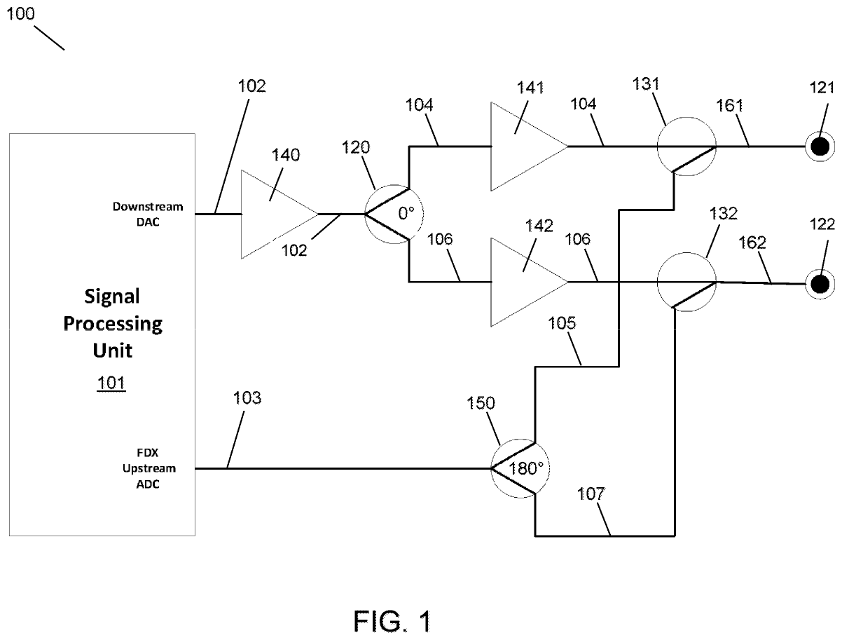

FIG. 1 shows a first exemplary embodiment of an internal reflection cancelling full duplex node 100. The first embodiment internal reflection cancelling full duplex node 100 is a two-port internal reflection-cancelling full duplex node configured for generating, splitting, and transmitting a downstream signal output from two ports, each configured for receiving two upstream signals, one through each of the two ports, and configured for cancelling reflections of the downstream signal from the two ports.

The first embodiment internal reflection cancelling full duplex node 100 includes a signal processing unit 101. The signal processing unit 101 is coupled to a primary downstream line 102 and a primary upstream line 103. The signal processing unit 101 is configured for generating a downstream signal on the primary downstream line 102 and configured for receiving upstream signals on the primary upstream line 103. The upstream and downstream signals share the same frequency band. A Cable Modem Termination System (not part of the node 100, not shown) is configured for coordinating with the signal processing unit 101 and the downstream cable modems so that the signal processing unit 101 and the cable modems do not transmit at the same time.

A downstream splitter 120 is part of the first embodiment internal reflection cancelling full duplex node 100. The downstream splitter 120 has an input coupled to the primary downstream line 102, a first output coupled to a first downstream line 104, and a second output coupled to a second downstream line 106. The downstream splitter 120 is configured for splitting a signal entering its input into a first signal leaving its first output and second signal leaving its second output. For example, when the downstream signal enters the input of the downstream splitter 120, it is split into a first split of the downstream signal and a second split of the downstream signal, carried by the first downstream line 104 and the second downstream line 106 respectively. The first split of the downstream signal and the second split of the downstream signal have the same waveform as the downstream signal but less amplitude as a result of the splitting. The downstream splitter 120 is a zero degree splitter, configured for inducing a relative phase shift of zero degrees between the signal leaving its first output and the signal leaving its second output.

A first upstream splitter 131 and a second upstream splitter 132 are also part of the first embodiment internal reflection cancelling full duplex node 100. The first upstream splitter 131 has an input coupled to a first bidirectional line 161, has a first output coupled to the first downstream line 104, and has a second output coupled to a first upstream line 105. The second upstream splitter 132 has an input coupled to a second bidirectional line 162, has a first output coupled to the second downstream line 106, and has a second output coupled to a second upstream line 107. The first bidirectional line 161 and the second bidirectional line 162 terminate at a first port 121 and a second port 122 respectively. Each of the ports 121, 122 is configured for connecting to an external coaxial cable line that ultimately connects with one or more cable modems or other subscriber device(s).

Each of the upstream splitters 131, 132 is configured for splitting a signal coming into its input, sending most of the signal through the second output to the respective upstream line 105, 107 and sending a smaller portion of the signal through the first output to the respective downstream line 104, 106. In other embodiments, the upstream signal may be evenly divided between the first and second outputs of the upstream splitters 131, 132. The split proportion is the same or nearly the same for both the upstream splitters 131, 132. A first upstream signal entering the first bidirectional line 161 will be split by the first upstream splitter 131, sending part of the first upstream signal through the first upstream line 105 and part through the first downstream line 104 toward the downstream splitter 120. Likewise, a second upstream signal coming in on the second bidirectional line 162 will be split by the second upstream splitter 132, sending part of the first upstream signal through the second upstream line 107 and part through the second downstream line 106 toward the downstream splitter 120. Each of the upstream splitters 131, 132 are configured for allowing a downstream signal to pass through to the ports 121, 122 with little or no attenuation. Each of the upstream splitters 131, 132, is configured for inducing a relative phase shift between the signal entering its input and the signal exiting its second output. The relative phase shift induced is the same or nearly the same for both the upstream splitters 131, 132.

An upstream combiner 150 is also part of the first embodiment internal reflection cancelling full duplex node 100. The upstream combiner 150 has a first input coupled to the first upstream line 105, a second input coupled to the second upstream line 107, and an output coupled to the primary upstream line 103. The upstream combiner 150 is configured for combining a first signal entering its first input and a second signal entering its second input into an output signal leaving its output. The upstream combiner 150 is a 180-degree combiner configured for inducing a 180 degree relative phase shift between the signal entering its first input and the signal entering its second input as they are combined.

Due to the multiple splitting of the downstream signal, the strength of the downstream signal is attenuated. To boost signal strength, the first embodiment internal reflection cancelling full duplex node 100 has a launch amplifier 140, a first boost amplifier 141, and a second boost amplifier 142. The launch amplifier 140 is in line with and part of the primary downstream line 102 between the signal processing unit 101 and the downstream splitter 120 with part of the primary downstream line 102 between the signal processing unit 101 and the launch amplifier 140 and part of the primary downstream line 102 between the launch amplifier 140 and the downstream splitter 120. The first boost amplifier 141 is in line with and part of the first downstream line 104 between the downstream splitter 120 and the first upstream splitter 131 with part of the first downstream line 104 coupled to an upstream side of the first boost amplifier 141 and part of the first downstream line 104 coupled to a downstream side of the first boost amplifier 141. The second boost amplifier 142 is in line with and part of the second downstream line 106 between the downstream splitter 120 and the second upstream splitter 132 with part of the second downstream line 106 coupled to an upstream side of the second boost amplifier 142 and part of the second downstream line 106 coupled to a downstream side of the second boost amplifier 142. The first boost amplifier 141 and the second boost amplifier 142 are configured to output identical or nearly identical output signals for identical input signals.

Reflections of a downstream signal can return upstream along with upstream signals and pass through the primary upstream line 103 to the signal processing unit 101. These reflections can cause echoes that need to be cancelled in order to achieve the desired performance level. Complex signal processing is required to process the received upstream signals and cancel out the reflections or echoes of the downstream signal. The signal processing unit 101 is configured for echo cancellation using signal processing, but the total amount of signal processing echo cancellation is limited. Since the reflections can be internal to the first embodiment node 100 or external (from the cable plant), minimizing the internal reflections as much as possible is desired in order to maintain as much of the total echo cancellation budget of the signal processing unit 101 as possible for dealing with external reflections.

The first embodiment internal reflection cancelling full duplex node 100 is configured to cancel reflections of a downstream signal from the ports 121, 122 before they reach the upstream receiver of the signal processing unit 101 via the primary upstream line 103. The signal processing unit 101 transmits a downstream signal through the primary downstream line 102 to the downstream splitter 120 where it is split into a first split of the downstream signal on the first downstream line 104 and a second split of the downstream signal on the second downstream line 106 with zero degrees of phase shift between the first and second split of the downstream signal. The first and second splits of the downstream signal pass respectively through the first and second upstream splitters 131, 132 and out through the first port 121 and the second port 122. Reflections of the first split of the downstream signal propagate back from the first port 121 on the first bidirectional line 161 and reflections of the second split of the downstream signal propagate back from the second port 122 on the second bidirectional line 162. The reflections of the first and second splits of the downstream signal respectively pass through the first and second upstream splitters 131, 132, respectively pass through the first and second upstream lines 105, 107 and through the upstream combiner 150 to the primary upstream line 103. The paths followed by the reflections of the first and second splits of the downstream signal have the same length and same propagation characteristics from the downstream splitter 120 to the first and second ports 121, 122 to the upstream combiner 150. Therefore, when the reflections of the first and second splits of the downstream signal reach the upstream combiner 150, they should have identical or nearly identical waveforms. Since the upstream combiner 150 is a 180-degree combiner, it induces a 180 degree relative phase shift between the reflection of the first split of the downstream signal and the reflection of the second split of the downstream signal. The reflections of the first and second splits of the downstream signal will completely cancel or nearly cancel each other in the upstream combiner 150. The Cable Modem Termination System (CMTS) ensures that only one upstream signal at the same time is coming from the cable modems connected to the ports 121, 122, so there is no cancellation or interference between upstream signals at the upstream combiner 150. An upstream signal will pass through the upstream combiner 150 and pass through to the primary upstream line 103 to the signal processing unit 101 with all or most of the reflections of the downstream signal from the ports 121, 122 removed.

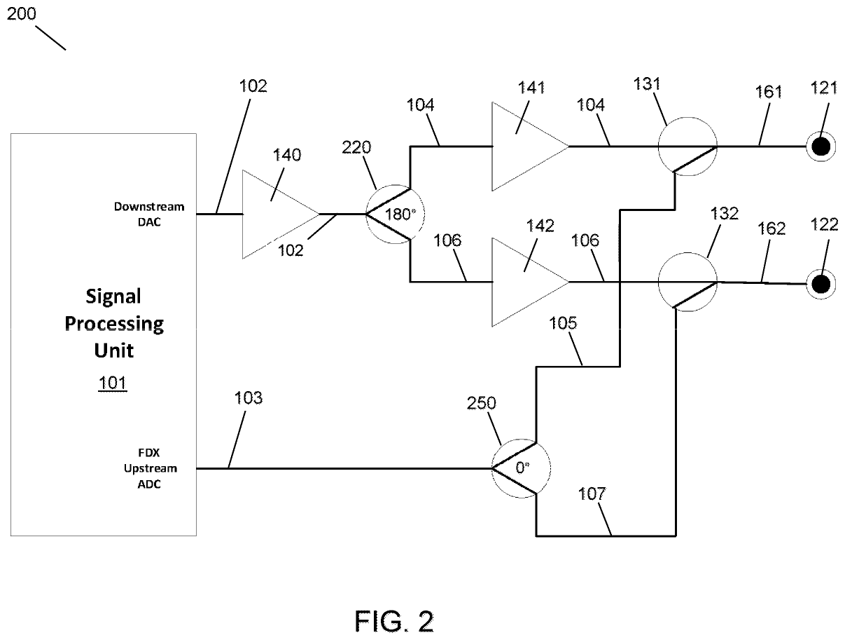

FIG. 2 shows a second exemplary embodiment of an internal reflection cancelling full duplex node 200. The second embodiment node 200 is identical to the first embodiment node 100 shown in FIG. 1 except for a few differences noted hereafter. The zero degree downstream splitter 120 and the 180 degree upstream combiner 150 of the first embodiment node 100 are replaced with a 180 degree downstream splitter 220 and a 0 degree upstream combiner 250 in the second embodiment node 200.

The second embodiment node 200 is configured to achieve the same results as the first embodiment node 100. The signal processing unit 101 transmits a downstream signal through the primary downstream line 102 to the downstream splitter 220 where it is split into a first split of the downstream signal on the first downstream line 104 and a second split of the downstream signal on the second downstream line 106. The downstream splitter 220 introduces 180 degrees of phase shift between the first and second splits of the downstream signal. The first and second splits of the downstream signal pass respectively through the first and second upstream splitters 131, 132 and out through the first port 121 and the second port 122. Reflections of the first split of the downstream signal propagate back from the first port 121 on the first bidirectional line 161 and reflections of the second split of the downstream signal propagate back from the second port 122 on the second bidirectional line 162. The reflections of the first and second splits of the downstream signal respectively pass through the first and second upstream splitters 131, 132, respectively pass through the first and second upstream lines 105, 107 and through the upstream combiner 250 to the primary upstream line 103. The paths followed by the reflections of the first and second splits of the downstream signal have the same length and same propagation characteristics from the downstream splitter 220 to the first and second ports 121, 122 to the upstream combiner 250. Therefore, when the reflections of the first and second splits of the downstream signal reach the upstream combiner 250, they should have identical or nearly identical waveforms except for a relative phase shift of 180 degrees. Since the upstream combiner 250 is a 0-degree combiner, it does not change the relative phase between the reflection of the first split of the downstream signal and the reflection of the second split of the downstream signal. The reflections of the first and second splits of the downstream signal will completely cancel or nearly cancel each other out in the upstream combiner 250. The CMTS ensures that only one upstream signal at the same time is coming from the cable modems connected to the ports 121, 122, so there is no interference between upstream signals at the upstream combiner 250. An upstream signal will pass through the upstream combiner 250 and pass through to the primary upstream line 103 to the signal processing unit 101 with all or most of the reflections of the downstream signal from the ports 121, 122 removed.

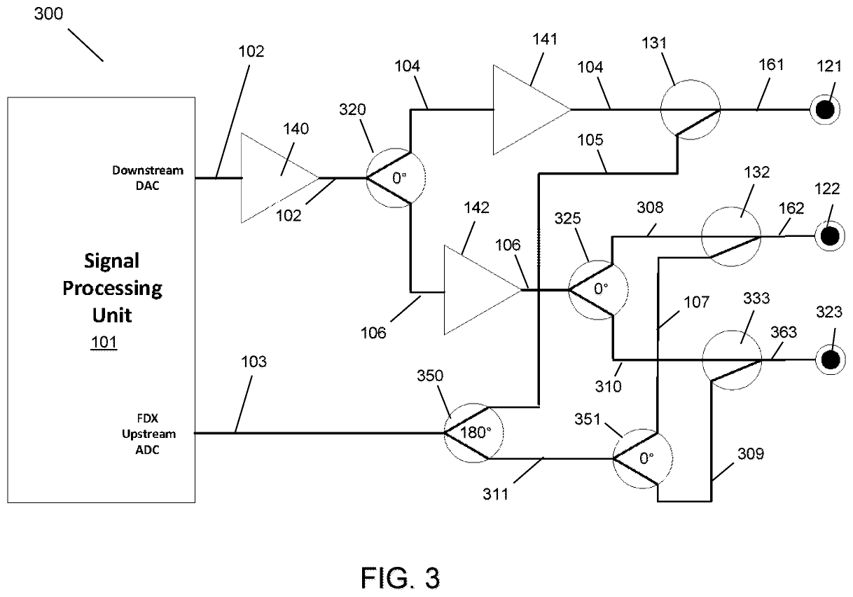

FIG. 3 shows a third exemplary embodiment of an internal reflection cancelling full duplex node 300. The third embodiment internal reflection cancelling full duplex node 300 is a three-port internal reflection cancelling full duplex node configured for generating, splitting, and transmitting a downstream signal out three ports, configured for receiving three upstream signals, one through each of the three ports, and configured for cancelling reflections of the downstream signal from the three ports.

The third embodiment internal reflection cancelling full duplex node 300 is based on the first embodiment node 100 shown in FIG. 1 with modifications and additions noted hereafter.

The third embodiment internal reflection cancelling full duplex node 300 includes a signal processing unit 101. The signal processing unit 101 is coupled to a primary downstream line 102 and a primary upstream line 103. The signal processing unit 101 is configured for generating a downstream signal on the primary downstream line 102 and configured for receiving upstream signals on the primary upstream line 103. The upstream and downstream signals share the same frequency band. A Cable Modem Termination System (not part of the node 300, not shown) is configured for coordinating with the signal processing unit 101 and the downstream cable modems so that the signal processing unit 101 and the cable modems do not transmit at the same time.

A first downstream splitter 320 is part of third embodiment internal reflection cancelling full duplex node 300. The first downstream splitter 320 has an input coupled to the primary downstream line 102, a first output coupled to a first downstream line 104, and a second output coupled to a second downstream line 106. The first downstream splitter 320 is configured for splitting a signal entering its input into a first signal leaving its first output and second signal leaving its second output. For example, when a downstream signal enters the input of the first downstream splitter 320, it is split into a first split of the downstream signal and a second split of the downstream signal, carried by the first downstream line 104 and the second downstream line 106 respectively. The first split of the downstream signal and the second split of the downstream signal have the same waveform as the downstream signal but less amplitude as a result of the splitting. The first downstream splitter 320 is a zero degree splitter, configured for inducing a relative phase shift of zero degrees between the signal leaving its first output and the signal leaving its second output.

A second downstream splitter 325 is part of third embodiment internal reflection cancelling full duplex node 300. The second downstream splitter 325 has an input coupled to the second downstream line 106, a first output coupled to a third downstream line 308, and a second output coupled to a fourth downstream line 310. The second downstream splitter 325 is configured for splitting a signal entering its input into a first signal leaving its first output and second signal leaving its second output. For example, when the second split of the downstream signal enters the input of the second downstream splitter 325, it is split into a third split of the downstream signal and a fourth split of the downstream signal, carried by the third downstream line 308 and the fourth downstream line 310 respectively. The second downstream splitter 325 is a zero degree splitter, configured for inducing a relative phase shift of zero degrees between the signal leaving its first output and the signal leaving its second output.

A first upstream splitter 131, a second upstream splitter 132, and a third upstream splitter 333 are also part of the third embodiment internal reflection cancelling full duplex node 300. The first upstream splitter 131 has an input coupled to a first bidirectional line 161, has a first output coupled to the first downstream line 104, and has a second output coupled to a first upstream line 105. The second upstream splitter 132 has an input coupled to a second bidirectional line 162, has a first output coupled to the third downstream line 308, and has a second output coupled to a second upstream line 107. The third upstream splitter 333 has an input coupled to third bidirectional line 363, has a first output coupled to the fourth downstream line 310, and has a second output coupled to a third upstream line 309. The first bidirectional line 161, the second bidirectional line 162, and the third bidirectional line 363 terminate at a first port 121, a second port 122, and a third port 323 respectively. Each of the ports 121, 122, 323 is configured for connecting to an external coaxial cable line that ultimately connects with one or more cable modems.

Each of the upstream splitters 131, 132, 333 is configured for splitting a signal coming into its input, sending most of the signal through the second output to the respective upstream line 105, 107, 309 and sending a smaller portion of the signal through the first output to the respective downstream line 104, 308, 310. In other embodiments, the upstream signal may be evenly divided between the first and second outputs of the upstream splitters 131, 132, 333. The split proportion is the same or nearly the same for all the upstream splitters 131, 132, 333. A first upstream signal coming in on the first bidirectional line 161 will be split by the first upstream splitter 131, sending part of the first upstream signal through the first upstream line 105 and part through the first downstream line 104 toward the first downstream splitter 320. Likewise, a second upstream signal coming in on the second bidirectional line 162 will be split by the second upstream splitter 132, sending part of the first upstream signal through the second upstream line 107 and part through the third downstream line 308 toward the second downstream splitter 325. Finally, a third upstream signal coming in on the third bidirectional line 363 will be split by the third upstream splitter 333, sending part of the third upstream signal through the third upstream line 309 and part through the fourth downstream line 310 toward the second downstream splitter 325.

Each of the upstream splitters 131, 132, 333 are configured for allowing a downstream signal to pass through to the ports 121, 122, and 323, respectively, with little or no attenuation. Each of the upstream splitters 131, 132, 333 is configured for inducing a relative phase shift between the signal entering its input and the signal exiting its second output. The relative phase shift induced is the same or nearly the same for all the upstream splitters 131, 132, 333.

A first upstream combiner 350 and a second upstream combiner 351 are also part of the third embodiment internal reflection cancelling full duplex node 300. The second upstream combiner 351 has a first input coupled to the second upstream line 107, a second input coupled to the third upstream line 309, and an output coupled to a fourth upstream line 311. The second upstream combiner 351 is configured for combining a first signal entering its first input and a second signal entering its second input into an output signal leaving its output. The second upstream combiner 351 is a zero-degree combiner configured for inducing a relative phase shift of zero degrees between the signal entering its first input and the signal entering its second input as they are combined.

The first upstream combiner 350 has a first input coupled to the first upstream line 105, a second input coupled to fourth upstream line 311, and an output coupled to the primary upstream line 103. The first upstream combiner 350 is configured for combining a first signal entering its first input and a second signal entering its second input into an output signal leaving its output. The first upstream combiner 350 is a 180-degree combiner configured for introducing a relative phase shift of 180 degrees between the signal entering its first input and the signal entering its second input as they are combined.

Due to the multiple splitting of the downstream signal, the strength of the downstream signal is attenuated. To boost signal strength, the third embodiment internal reflection cancelling full duplex node 300 has a launch amplifier 140, a first boost amplifier 141, and a second boost amplifier 142. The launch amplifier 140 is in line with and part of the primary downstream line 102 between the signal processing unit 101 and the first downstream splitter 320 with part of the primary downstream line 102 between the signal processing unit 101 and the launch amplifier 140 and part of the primary downstream line 102 between the launch amplifier 140 and the first downstream splitter 320. The first boost amplifier 141 is in line with and part of the first downstream line 104 between the first downstream splitter 320 and the first upstream splitter 131 with part of the first downstream line 104 coupled to an upstream side of the first boost amplifier 141 and part of the first downstream line 104 coupled to a downstream side of the first boost amplifier 141. The second boost amplifier 142 is in line with and part of the second downstream line 106 between the first downstream splitter 320 and the second downstream splitter 325 with part of the second downstream line 106 coupled to an upstream side of the second boost amplifier 142 and part of the second downstream line 106 coupled to a downstream side of the second boost amplifier 142. The first boost amplifier 141 and the second boost amplifier 142 are configured to output identical or nearly identical output signals for identical input signals.

The third embodiment internal reflection cancelling full duplex node 300 is configured to cancel reflections of a downstream signal from the ports 121, 122, 323 before they reach the upstream receiver of the signal processing unit 101 via the primary upstream line 103. The signal processing unit 101 transmits a downstream signal through the primary downstream line 102 to the first downstream splitter 320 where it is split into a first split of the downstream signal on the first downstream line 104 and a second split of the downstream signal on the second downstream line 106 with zero degrees of phase shift between the first and second splits of the downstream signal. The second split of the downstream signal is split into a third split of the downstream signal on the third downstream line 308 and a fourth split of the downstream signal on the fourth downstream line 310 with zero degrees of phase shift between the third and fourth splits of the downstream signal.

The first, third and fourth splits of the downstream signal pass respectively through the first, second and third upstream splitters 131, 132, 333 and out through the first port 121, the second port 122, and the third port 323. Reflections of the first split of the downstream signal propagate back from the first port 121 on the first bidirectional line 161, reflections of the third split of the downstream signal propagate back from the second port 122 on the second bidirectional line 162, and reflections of the fourth split of the downstream signal propagate back from the third port 323 on the third bidirectional line 363. The reflections of the first, third, and fourth splits of the downstream signal respectively pass through the first, second, and third upstream splitters 131, 132, 333, respectively pass through the first, second, and third upstream lines 105, 107, 309.

The reflections of the third and fourth splits of the downstream signal are combined in the second upstream combiner 351. The paths followed by the reflections of the third and fourth splits of the downstream signal have the same distance and same propagation characteristics from the first downstream splitter 320 to the second and third ports 122, 323 to the second upstream combiner 351. Therefore, when the reflections of the third and fourth splits of the downstream signal reach the second upstream combiner 351, they should have identical or nearly identical waveforms and are in phase. Since the second upstream combiner 351 is a zero degree combiner, it introduces a relative phase shift of zero degrees between the reflection of the third split of the downstream signal and the reflection of the fourth split of the downstream signal. The reflections of the third and fourth splits of the downstream signal positively reinforce each other.

The reflection of first split of the downstream signal is combined in the first upstream combiner 350 with the combined third and fourth splits of the downstream signal. The path of the first split of the downstream signal from the first downstream splitter 320 to the first port 121 back through the first upstream splitter 131 to the upstream combiner 350 has the same distance and same propagation characteristics as the paths followed by the reflections of the third and fourth splits of the downstream signal from the first downstream splitter 320 to the second and third ports 122, 323 back through upstream splitters 132, 333, through the second upstream combiner 351 to the first upstream combiner 350. The reflection of the first split of the downstream signal is completely cancelled or nearly cancelled in the first upstream combiner 350 by the combined reflections of the third and fourth splits of the downstream signal. This is because the splitter 325 attenuates the signals that reach ports 122 and 323 to each be about one half the signal strength of the downstream signal reaching port 121. Therefore, when the reflections from ports 122 and 323 are combined, their signal strength is equal to, or approximately equal to the signal strength of the reflection from port 121. When the reflection from port 121 is phase shifted relative to, and combined with, the reflections from ports 122 and 323, they cancel each other.

In some alternative embodiments of the third embodiment internal reflection cancelling full duplex node 300, the phase shifting properties of the first downstream splitter 320 and the first upstream combiner 350 are reversed, with the first downstream splitter 320 as a 180-degree splitter and the first upstream combiner 350 as a zero degree combiner. This will achieve the same cancellation of the reflections of the splits of the downstream signal off the ports 121, 122, 323.

The CMTS ensures that only one upstream signal at the same time is coming from the cable modems connected to the ports 121, 122, 323 so there is no cancellation or interference between upstream signals. An upstream signal will pass through the upstream combiners 350, 351 and pass through to the primary upstream line 103 to the signal processing unit 101 with all or most of the reflections of the downstream signal from the ports 121, 122, 323 removed.

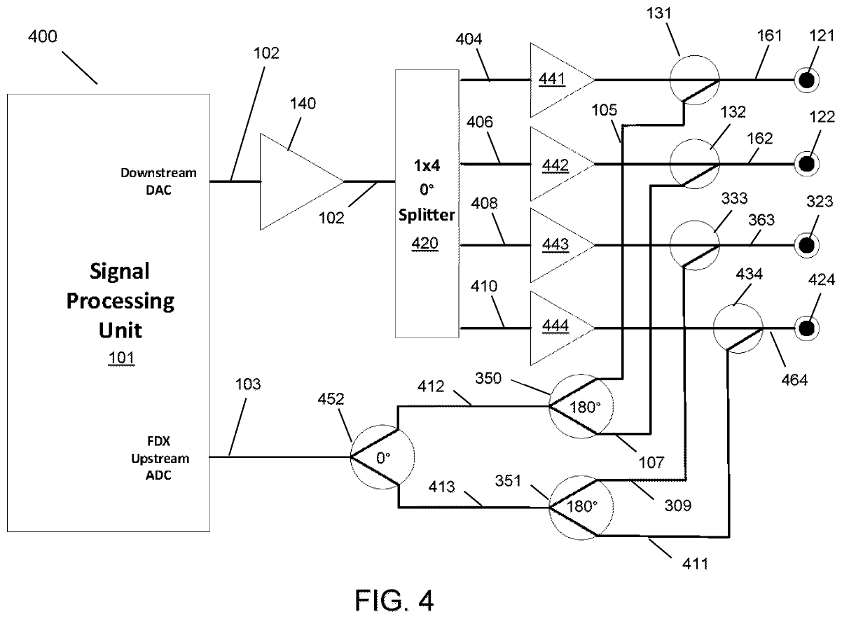

FIG. 4 shows a fourth exemplary embodiment of an internal reflection cancelling full duplex node 400. The fourth embodiment internal reflection cancelling full duplex node 400 is a four-port internal reflection cancelling full duplex node configured for generating, splitting, and transmitting a downstream signal out four ports, configured for receiving four upstream signals, one through each of the four ports, and configured for cancelling reflections of the downstream signal from the four ports.

The fourth embodiment internal reflection cancelling full duplex node 400 is based on the first embodiment node 100 shown in FIG. 1 with modifications and additions noted hereafter.

The fourth embodiment internal reflection cancelling full duplex node 400 includes a signal processing unit 101. The signal processing unit 101 is coupled to a primary downstream line 102 and a primary upstream line 103. The signal processing unit 101 is configured for generating a downstream signal on the primary downstream line 102 and configured for receiving upstream signals on the primary upstream line 103. The upstream and downstream signals share the same frequency band. A Cable Modem Termination System (not part of the node 400, not shown) is configured for coordinating with the signal processing unit 101 and the downstream cable modems so that the signal processing unit 101 and the cable modems do not transmit at the same time.

A 1×4 downstream splitter 420 is part of fourth embodiment internal reflection cancelling full duplex node 400. The 1×4 downstream splitter 420 has an input coupled to the primary downstream line 102, a first output coupled to a first downstream line 404, a second output coupled to a second downstream line 406, a third output coupled to a third downstream line 408, and a fourth output coupled to a fourth downstream line 410. The 1×4 downstream splitter 420 is configured for splitting a signal entering its input into a first signal leaving its first output, a second signal leaving its second output, a third signal leaving its third output, and a fourth signal leaving its fourth output. For example, when a downstream signal enters the input of the 1×4 downstream splitter 420, it is split into a first, second, third, and fourth splits of the downstream signal, carried by the first downstream line 404, the second downstream line 406, the third downstream line 408, and the fourth downstream line 410 respectively. All the splits of the downstream signal have the same waveform as the downstream signal but less amplitude as a result of the splitting. The 1×4 downstream splitter 420 is a zero degree splitter, configured for inducing a relative phase shift of zero degrees between the signals leaving its four outputs.

A first upstream splitter 131, a second upstream splitter 132, a third upstream splitter 333 and a fourth upstream splitter 434 are also part of the fourth embodiment internal reflection cancelling full duplex node 400. The first upstream splitter 131 has an input coupled to a first bidirectional line 161, has a first output coupled to the first downstream line 404, and has a second output coupled to a first upstream line 105. The second upstream splitter 132 has an input coupled to a second bidirectional line 162, has a first output coupled to the second downstream line 406, and has a second output coupled to a second upstream line 107. The third upstream splitter 333 has an input coupled to third bidirectional line 363, has a first output coupled to the third downstream line 408, and has a second output coupled to a third upstream line 309. The fourth upstream splitter 434 has an input coupled to fourth bidirectional line 464, has a first output coupled to the fourth downstream line 410, and has a second output coupled to a fourth upstream line 411. The first bidirectional line 161, the second bidirectional line 162, the third bidirectional line 363, and the fourth bidirectional line 464 terminate respectively at a first port 121, a second port 122, a third port 323, and a fourth port 424. Each of the ports 121, 122, 323, 424 is configured for connecting to an external coaxial cable line that ultimately connects with one or more cable modems.

Each of the upstream splitters 131, 132, 333, 434 is configured for splitting a signal coming in its input, sending most of the signal through the second output to the respective upstream line 105, 107, 309, 411 and sending a smaller portion of the signal through the first output to the respective downstream line 404, 406, 408, 410. In other embodiments, the upstream signal may be evenly divided between the first and second outputs of the upstream splitters 131, 132, 333, 434. The split proportion is the same or nearly the same for all the upstream splitters 131, 132, 333, 434.

A first upstream signal coming in on the first bidirectional line 161 will be split by the first upstream splitter 131, sending part of the first upstream signal through the first upstream line 105 and part through the first downstream line 404 toward the 1×4 downstream splitter 420. Likewise, a second upstream signal coming in on the second bidirectional line 162 will be split by the second upstream splitter 132, sending part of the second upstream signal through the second upstream line 107 and part through the second downstream line 406 toward the 1×4 downstream splitter 420. A third upstream signal coming in on the third bidirectional line 363 will be split by the third upstream splitter 333, sending part of the third upstream signal through the third upstream line 309 and part through the third downstream line 408 toward the 1×4 downstream splitter 420. A fourth upstream signal coming in on the fourth bidirectional line 464 will be split by the fourth upstream splitter 434, sending part of the fourth upstream signal through the fourth upstream line 411 and part through the fourth downstream line 410 toward the 1×4 downstream splitter 420.

Each of the upstream splitters 131, 132, 333, 434 are configured for allowing a downstream signal to pass through from the first output to the input with little or no attenuation. Each of the upstream splitters 131, 132, 333, 434 is configured for inducing a relative phase shift between the signal entering its input and the signal exiting its second output. The relative phase shift induced is the same or nearly the same for all the upstream splitters 131, 132, 333, 434.

A first upstream combiner 350, a second upstream combiner 351, and a third upstream combiner 452 are also part of the fourth embodiment internal reflection cancelling full duplex node 400. The first upstream combiner 350 has a first input coupled to the first upstream line 105, a second input coupled to the second upstream line 107, and an output coupled to a first combined line 412. The first upstream combiner 350 is configured for combining a first signal entering its first input and a second signal entering its second input into an output signal leaving its output. The first upstream combiner 350 is a 180 degree combiner configured for inducing a relative phase shift of 180 degrees between the signal entering its first input and the signal entering its second input as they are combined.

The second upstream combiner 351 has a first input coupled to the third upstream line 309, a second input coupled to the fourth upstream line 411, and an output coupled to a second combined line 413. The second upstream combiner 351 is configured for combining a first signal entering its first input and a second signal entering its second input into an output signal leaving its output. The second upstream combiner 351 is a 180 degree combiner configured for inducing a relative phase shift of 180 degrees between the signal entering its first input and the signal entering its second input as they are combined.

The third upstream combiner 452 has a first input coupled to the first combined line 412, a second input coupled to second combined line 413, and an output coupled to the primary upstream line 103. The third upstream combiner 452 is configured for combining a first signal entering its first input and a second signal entering its second input into an output signal leaving its output. The third upstream combiner 452 is a zero degree combiner configured for introducing a relative phase shift of 0 degrees between the signal entering its first input and the signal entering its second input as they are combined.

Due to the multiple splitting of the downstream signal, the strength of the downstream signal is attenuated. To boost signal strength, the fourth embodiment internal reflection cancelling full duplex node 400 has a launch amplifier 140, a first boost amplifier 441, a second boost amplifier 442, a third boost amplifier 443, and a fourth boost amplifier 444. The launch amplifier 140 is in line with and part of the primary downstream line 102 between the signal processing unit 101 and the 1×4 downstream splitter 420 with part of the primary downstream line 102 between the signal processing unit 101 and the launch amplifier 140 and part of the primary downstream line 102 between the launch amplifier 140 and the 1×4 downstream splitter 420. The first boost amplifier 441 is in line with and part of the first downstream line 404 between the 1×4 downstream splitter 420 and the first upstream splitter 131 with part of the first downstream line 404 coupled to an upstream side of the first boost amplifier 441 and part of the first downstream line 404 coupled to a downstream side of the first boost amplifier 441. The second boost amplifier 442 is in line with and part of the second downstream line 406 between the first downstream splitter 420 and the second upstream splitter 132 with part of the second downstream line 406 coupled to an upstream side of the second boost amplifier 442 and part of the second downstream line 406 coupled to a downstream side of the second boost amplifier 442. The third boost amplifier 443 is in line with and part of the third downstream line 408 between the first downstream splitter 420 and the third upstream splitter 333 with part of the third downstream line 408 coupled to an upstream side of the third boost amplifier 443 and part of the third downstream line 408 coupled to a downstream side of the third boost amplifier 443. The fourth boost amplifier 444 is in line with and part of the fourth downstream line 410 between the first downstream splitter 420 and the fourth upstream splitter 434 with part of the fourth downstream line 410 coupled to an upstream side of the fourth boost amplifier 444 and part of the fourth downstream line 410 coupled to a downstream side of the fourth boost amplifier 444. The first, second, third, and fourth boost amplifiers 441, 442, 443, 444 are configured to output identical or nearly identical output signals for identical input signals.

The fourth embodiment internal reflection cancelling full duplex node 400 is configured to cancel reflections of a downstream signal from the ports 121, 122, 323, 424 before they reach the upstream receiver of the signal processing unit 101 via the primary upstream line 103. The signal processing unit 101 transmits a downstream signal through the primary downstream line 102 to the 1×4 downstream splitter 420 where it is split into a first split of the downstream signal on the first downstream line 404, a second split of the downstream signal on the second downstream line 406, a third split of the downstream signal on the third downstream line 408, and a fourth split of the downstream signal on the fourth downstream line 410 with zero degrees of phase shift between the first, second, third, and fourth splits of the downstream signal. The first, second, third, and fourth splits of the downstream signal pass respectively through the first, second, third, and fourth upstream splitters 131, 132, 333, 434 and out through the first, second, third and fourth ports 121, 122, 323, 424. Reflections of the first, second, third, and fourth splits of the downstream signal respectively propagate back from the first, second, third, and fourth ports 121, 122, 323, 424 on the first, second, third, and fourth bidirectional lines 161, 162, 363, 464. The reflections of the first, second, third, and fourth splits of the downstream signal respectively pass through the first, second, third, and fourth upstream splitters 131, 132, 333, 434, and respectively pass through the first, second, third, and fourth upstream lines 105, 107, 309, 411.

The reflections of the first and second splits of the downstream signal are combined in the first upstream combiner 350. The paths followed by the reflections of the first and second splits of the downstream signal have the same distance and same propagation characteristics from the 1×4 downstream splitter 420 to the first and second ports 121, 122 to the first upstream combiner 350. Therefore, when the reflections of the first and second splits of the downstream signal reach the first upstream combiner 350, they should have identical or nearly identical waveforms and are in phase. Since the first upstream combiner 350 is a 180 degree combiner, it introduces a relative phase shift of 180 degrees between the reflection of the first split of the downstream signal and the reflection of the second split of the downstream signal. The reflections of the first and second splits of the downstream signal are completely cancelled or nearly cancelled in the first upstream combiner 350.

The reflections of the third and fourth splits of the downstream signal are combined in the second upstream combiner 351. The paths followed by the reflections of the third and fourth splits of the downstream signal have the same distance and same propagation characteristics from the 1×4 downstream splitter 420 to the third and fourth ports 323, 424 to the second upstream combiner 351. Therefore, when the reflections of the third and fourth splits of the downstream signal reach the second upstream combiner 351, they should have identical or nearly identical waveforms and are in phase. Since the second upstream combiner 351 is a 180 degree combiner, it introduces a relative phase shift of 180 degrees between the reflection of the third split of the downstream signal and the reflection of the fourth split of the downstream signal. The reflections of the third and fourth splits of the downstream signal are completely cancelled or nearly cancelled in the second upstream combiner 351.

In some alternative embodiments of the fourth embodiment internal reflection cancelling full duplex node 400, the phase shifting properties of the first upstream combiner 350, the second upstream combiner 351, and the third upstream combiner 452 are reversed, with the third upstream combiner 452 as a 180-degree combiner while the first upstream combiner 350 and the second upstream combiner 351 are zero degree combiners. This will achieve the same cancellation of the reflections of a downstream signal off the ports 121, 122, 323, 424.

The CMTS ensures that only one upstream signal at the same time is coming from the cable modems connected to the ports 121, 122, 323, 424 so there is no cancellation or interference between upstream signals. An upstream signal will pass through the upstream combiners 350, 351, 452 and pass through to the primary upstream line 103 to the signal processing unit 101 with all or most of the reflections of the downstream signal from the ports 121, 122, 323, 424 removed.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An internal reflection cancelling full duplex node comprising:
a downstream splitter with an input coupled to a primary downstream line, a first output coupled to a first downstream line and a second output coupled to a second downstream line;
a first bidirectional line coupled to a first port;
a second bidirectional line coupled to a second port;
a first upstream splitter with an input coupled to the first port, a first output coupled to the first downstream line and a second output coupled to a first upstream line;
a second upstream splitter with an input coupled to the second port, a first output coupled to the second downstream line and a second output coupled to a second upstream line; and
an upstream combiner with a first input coupled to the first upstream line, a second input coupled to the second upstream line and an output coupled to a primary upstream line.

2. The internal reflection cancelling full duplex node of claim 1,
wherein the downstream splitter is configured for equally splitting a downstream signal entering the input of the downstream splitter into a first split of the downstream signal leaving the first output of the downstream splitter and a second split of the downstream signal leaving the second output of the downstream splitter.

3. The internal reflection cancelling full duplex node of claim 2,
wherein the downstream splitter is configured for inducing a relative phase shift of zero degrees between the first split of the downstream signal and the second split of the downstream signal; and
wherein the upstream combiner is configured for inducing a relative phase shift of 180 degrees between a reflection of the first split of the downstream signal entering its first output and a reflection of the second split of the downstream signal entering its second output.

4. The internal reflection cancelling full duplex node of claim 3,
wherein the primary downstream line includes a launch amplifier;
wherein the first downstream line includes a first boost amplifier; and
wherein the second downstream line includes a second boost amplifier.

5. The internal reflection cancelling full duplex node of claim 4,
wherein a first signal path from the downstream splitter to the first port back through the first upstream splitter to the upstream combiner has a path length and propagation characteristics that are identical to a second signal path from the downstream splitter to the second port back through the second upstream splitter to the upstream combiner.

6. The internal reflection cancelling full duplex node of claim 2,
wherein the downstream splitter is configured for inducing a relative phase shift of 180 degrees between the first split of the downstream signal and the second split of the downstream signal; and
wherein the upstream combiner is configured for inducing a relative phase shift of zero degrees between a reflection of the first split of the downstream signal entering its first input and a reflection of the second split of the downstream signal entering its second input.

7. The internal reflection cancelling full duplex node of claim 6,
wherein the primary downstream line includes a launch amplifier;
wherein the first downstream line includes a first boost amplifier; and
wherein the second downstream line includes a second boost amplifier.

8. The internal reflection cancelling full duplex node of claim 7,
wherein a first signal path from the downstream splitter to the first port back through the first upstream splitter to the upstream combiner has a path length and propagation characteristics that are identical to a second signal path from the downstream splitter to the second port back through the second upstream splitter to the upstream combiner.

9. The internal reflection cancelling full duplex node of claim 1, further comprising:
a signal processing unit with a transmitter coupled to the primary downstream line and receiver coupled to the primary upstream line.

10. An internal reflection cancelling full duplex node comprising:
a first downstream splitter with an input coupled to a primary downstream line, a first output coupled to a first downstream line and a second output coupled to a second downstream line;
a second downstream splitter with an input coupled to the second downstream line, a first output coupled to a third downstream line and a second output coupled to a fourth downstream line;
a first bidirectional line coupled to a first port;
a second bidirectional line coupled to a second port;
a third bidirectional line coupled to a third port;
a first upstream splitter with an input coupled to the first port, a first output coupled to the first downstream line and a second output coupled to a first upstream line;
a second upstream splitter with an input coupled to the second port, a first output coupled to the third downstream line and a second output coupled to a second upstream line;
a third upstream splitter with an input coupled to the third port, a first output coupled to the fourth downstream line and a second output coupled to a third upstream line;
a first upstream combiner with a first input coupled to the first upstream line, a second input coupled to a fourth upstream line and an output coupled to a primary upstream line; and
a second upstream combiner with a first input coupled to the second upstream line, a second input coupled to the third upstream line and an output coupled to the fourth upstream line.

11. The internal reflection cancelling full duplex node of claim 10,
wherein the first downstream splitter is configured for equally splitting a downstream signal entering the input of the first downstream splitter into a first split of the downstream signal leaving the first output of the first downstream splitter, a second split of the downstream signal leaving the second output of the first downstream splitter; and
wherein the second downstream splitter is configured for equally splitting the second split of the downstream signal entering the input of the second downstream splitter into a third split of the downstream signal leaving the first output of the second downstream splitter, a fourth split of the downstream signal leaving the second output of the second downstream splitter.

12. The internal reflection cancelling full duplex node of claim 11,
wherein the first downstream splitter is configured for inducing a relative phase shift of zero degrees between the first and second splits of the downstream signal;
wherein the second downstream splitter is configured for inducing a relative phase shift of zero degrees between the third and fourth splits of the downstream signal;
wherein the first upstream combiner is configured for inducing a relative phase shift of 180 degrees between a reflection of the first split of the downstream signal entering its first input and a combination of a reflection of the third split of the downstream signal and a reflection of the fourth split of the downstream signal entering its second input; and
wherein the second upstream combiner is configured for inducing a relative phase shift of zero degrees between a reflection of the third split of the downstream signal entering its first input and a reflection of the fourth split of the downstream signal entering its second input.

13. The internal reflection cancelling full duplex node of claim 12,
wherein the primary downstream line includes a launch amplifier;
wherein the first downstream line includes a first boost amplifier; and
wherein the second downstream line includes a second boost amplifier.

14. The internal reflection cancelling full duplex node of claim 13,
wherein a first signal path from the first downstream splitter to the first port back through the first upstream splitter to the first upstream combiner has a path length and propagation characteristics that are identical to a second signal path from the first downstream splitter to the second port back through the second upstream splitter through the second upstream combiner to the first upstream combiner and identical to a third signal path from the first downstream splitter to the third port back through the third upstream splitter through the second upstream combiner to the first upstream combiner.

15. An internal reflection cancelling full duplex node comprising:
a downstream splitter with an input coupled to a primary downstream line, a first output coupled to a first downstream line, a second output coupled to a second downstream line, a third output coupled to a third downstream line, and a fourth output coupled to a fourth downstream line;
a first bidirectional line coupled to a first port;
a second bidirectional line coupled to a second port;
a third bidirectional line coupled to a third port;
a fourth bidirectional line coupled to a fourth port;
a first upstream splitter with an input coupled to the first port, a first output coupled to the first downstream line and a second output coupled to a first upstream line;
a second upstream splitter with an input coupled to the second port, a first output coupled to the second downstream line and a second output coupled to a second upstream line;
a third upstream splitter with an input coupled to the third port, a first output coupled to the third downstream line and a second output coupled to a third upstream line;
a fourth upstream splitter with an input coupled to the fourth port, a first output coupled to the fourth downstream line and a second output coupled to a fourth upstream line;
a first upstream combiner with a first input coupled to the first upstream line, a second input coupled to the second upstream line and an output coupled to a first combined line;
a second upstream combiner with a first input coupled to the third upstream line, a second input coupled to the fourth upstream line and an output coupled to a second combined line; and
a third upstream combiner with a first input coupled to the first combined line, a second input coupled to the second combined line and an output coupled to a primary upstream line.

16. The internal reflection cancelling full duplex node of claim 15,
wherein the downstream splitter is configured for equally splitting a downstream signal entering the input of the downstream splitter into a first split of the downstream signal leaving the first output of the downstream splitter, a second split of the downstream signal leaving the second output of the downstream splitter, a third split of the downstream signal leaving the third output of the downstream splitter and a fourth split of the downstream signal leaving the fourth output of the downstream splitter.

17. The internal reflection cancelling full duplex node of claim 16,
wherein the downstream splitter is configured for inducing a relative phase shift of zero degrees between the first, second, third, and fourth splits of the downstream signal;
wherein the first upstream combiner is configured for inducing a relative phase shift of 180 degrees between a reflection of the first split of the downstream signal entering its first input and a reflection of the second split of the downstream signal entering its second input; and
wherein the second upstream combiner is configured for inducing a relative phase shift of 180 degrees between a reflection of the third split of the downstream signal entering its first input and a reflection of the fourth split of the downstream signal entering its second input.

18. The internal reflection cancelling full duplex node of claim 17,
wherein the primary downstream line includes a launch amplifier;
wherein the first downstream line includes a first boost amplifier;
wherein the second downstream line includes a second boost amplifier;
wherein the third downstream line includes a third boost amplifier; and
wherein the fourth downstream line includes a fourth boost amplifier.

19. The internal reflection cancelling full duplex node of claim 18,
wherein a first signal path from the downstream splitter to the first port back through the first upstream splitter to the first upstream combiner has a path length and propagation characteristics that are identical to a second signal path from the downstream splitter to the second port back through the second upstream splitter to the first upstream combiner; and
wherein a third signal path from the downstream splitter to the third port back through the third upstream splitter to the second upstream combiner has a path length and propagation characteristics that are identical to a fourth signal path from the downstream splitter to the fourth port back through the fourth upstream splitter to the second upstream combiner.

20. A method for internal reflection cancelling in full duplex node comprising the steps of:
splitting, in a downstream splitter, a downstream signal equally into a first split of the downstream signal and a second split of the downstream signal;
transmitting the first split of the downstream signal through a first upstream splitter to a first port;
transmitting the second split of the downstream signal through a second upstream splitter to a second port;
passing a reflection of the first split of the downstream signal through the first upstream splitter to an upstream combiner;
passing a reflection of the second split of the downstream signal through the second upstream splitter to the upstream combiner;
wherein a first signal path from the downstream splitter to the first port back through the first upstream splitter to the upstream combiner has a path length and propagation characteristics that are identical to a second signal path from the downstream splitter to the second port back through the second upstream splitter to the upstream combiner;
inducing, in the upstream combiner, a 180 degree relative phase shift between the reflection of the first split of the downstream signal and the reflection of the second split of the downstream signal; and
combining, in the upstream combiner, the reflection of the first split of the downstream signal and of the reflection of the second split of the downstream signal.
